(19) United States
(12) Patent Application Publication
(10) Pub. No.: US 2005/0284507 A1
(43) Pub. Date: Dec. 29, 2005

(54) Cleaning device having at least one cleaning region, preferably a dishwasher

(76) Inventor: Jurgen Boesche, Edewecht (DE)

Correspondence Address: WILLIAM COLLARD;COLLARD & ROE, P.C., 1077 NORTHERN BOULEVARD, ROSLYN, NY, 11576, US

(21) Appl. No.: 11/097,830

(22) Filed: Apr. 1, 2005

(30) Foreign Application Priority Data
Apr. 2, 2004 (DE) 10 2004 016 270.0

(51) Int. Cl. B08B 3/00

(52) U.S. Cl. 134/56 D; 134/58 D

(57) ABSTRACT

In the case of a cleaning device having at least one cleaning region, preferably a dishwasher having a dishwashing chamber, comprising a drive for a pump, which drive is regulated in terms of speed of rotation, for a cleaning agent that is to be introduced into the cleaning region, preferably for water, which is passed in circulation through at least one filter, it is provided that the speed of rotation regulator of the drive has at least one monitoring device for determining the speed of rotation of the pump and/or the power consumption of the pump drive assigned to it, and that the monitoring device is linked with the speed of rotation regulator in such a manner as to cause an increase in the speed of rotation. With this cleaning device, its users can be admonished to maintain operation of the cleaning device over a long period of time.

The invention relates to a cleaning device having at least one cleaning region, preferably a dishwasher having a dishwashing chamber, comprising a drive for a pump, which drive is regulated in terms of speed of rotation, for a cleaning agent that is to be introduced into the cleaning region, preferably for water, which is passed in circulation through at least one filter.

Cleaning devices of the type stated initially are used to clean objects, for example dishes, pots, or technical equipment. The objects to be cleaned are introduced into the cleaning region and cleaned there. For this purpose, a cleaning agent is introduced into the cleaning region, for example water to be introduced at high pressure is introduced into the dishwashing chamber of a dishwasher.

In order to introduce the cleaning agent, a pump is used, with which the cleaning agent can be transported. In dishwashers, drives regulated in terms of speed of rotation are increasingly being used in these pumps, in order to pass the cleaning agent to the cleaning region in the required amount and with the required pressure. Drives regulated in terms of speed of rotation reduce the noises that are caused, and make a significant contribution to saving energy and water when using the cleaning device.

The cleaning agent is used multiple times in such cleaning devices. After it was introduced into the cleaning region by the pump, for a first cleaning pass, the cleaning water that is now dirty is collected again, passed through the filter, and passed to the pump to be fed into the cleaning region once again. After several cleaning passes, the used cleaning agent is finally moved out of the cleaning region and, if necessary, a rinsing agent, which is preferably clear, is introduced, again by way of the pump.

Particularly in the case of dishwashers, very dirty items are frequently placed into the dishwashing chamber. For example, in the case of dishwashers, the dishes introduced into them frequently have food residues on them. When these dishes are cleaned, the food residues are washed off and filtered out of the cleaning agent, if it is filtered. This means that the food residues and other garbage collect in the filter. In order for the filter not to become clogged, it must be taken out of the cleaning device from time to time, and cleaned.

Some users of cleaning devices neglect to clean the filter in timely manner. Frequently, such users introduce a large amount of garbage and food residues into a dishwasher or into another cleaning device. The filter contained in the cleaning device, for the cleaning agent, can become clogged, so that the ability of the cleaning device to function is at risk. For some customers, it is even necessary to dispose a chopping device ahead of the actual filter, in order to chop up pieces of bone, eggshells, or egg spoons that are introduced into the dishwasher, for example, to such a small size, before the cleaning agent is drawn off, that no blockage of the entire cleaning device can occur. These chopped residues must be pumped off into the sewer system, if necessary by a lye pump, in the final analysis.

The invention is based on the task of indicating a cleaning device of the type stated initially, with which users of a cleaning device can be encouraged to maintain the operation of the cleaning device over a long period of time, in inexpensive manner.

This task is accomplished, according to the invention, in that the speed of rotation regulator of the drive has at least one monitoring device for determining the speed of rotation of the pump and/or the power consumption of the pump drive assigned to it, and that the monitoring device is linked with the speed of rotation regulator in such a manner as to cause an increase in the speed of rotation.

The cleaning device according to the invention is characterized by a monitoring device that records physical data of the pump and its drive. By means of monitoring of these physical variables, conclusions can be drawn concerning the status of the filter for the cleaning agent. Specifically, if the monitoring device determines that the speed of rotation of the pump is remaining the same, but at the same time, an increase in the power consumption of the pump is taking place, the conclusion can be drawn that the filter is clogged. If the filter is clogged, the drive of the pump must apply greater power to pass the cleaning agent through, and therefore the power demand of the pump increases.

According to the invention, it is also provided that the monitoring device is linked with the speed of rotation regulator in such a manner as to bring about an increase in the speed of rotation. This link can advantageously be utilized to achieve an increase in the speed of rotation of the pump drive by way of the speed of rotation regulator, if the filter is clogged. By increasing the speed of rotation of the drive, the pump increases the transport pressure of the cleaning agent, for example in pulse-like manner, thereby making it possible for the filter to be flushed with great force. In this connection, flushing of the filter can take place in the flow-through direction of the filter or opposite the usual flow-through direction of the filter.

Preferably, in this connection, joint monitoring of the speed of rotation of the pump and of the power consumption of the pump drive takes place. However, it is also possible to provide the monitoring effort by monitoring only one variable, with the other conditions, for example the power consumption of the pump drive, being defined.

Aside from the speed of rotation of the pump or the power consumption of the pump drive, it is also possible, alternatively, to monitor the torque of the drive, using the monitoring device. A combination of monitoring the torque with monitoring one or both other physical variables is also possible.

According to a next further development of the invention, it is provided that the speed of rotation regulator is, at the same time, the monitoring device. The pump drive is a drive regulated in terms of speed of rotation, right from the start. Therefore the drive has a speed of rotation regulator assigned to it, with which the speed of rotation of the drive can be changed, and therefore can also be increased, in case of clogging, to flush the filter. The speed of rotation of the pump as well as the amount of the current for the drive, and also the torque of the pump are monitored for the purpose of regulating the speed of rotation, merely for the purpose of designing the most effective speed of rotation for the pump. The function of the monitoring device for determining that the filter has become clogged can be added to this regulation of the speed of rotation, for example by means of corresponding implementation in a software for regulating the speed of rotation or in a system control.

When it is found that the filter has become clogged, flushing can first take place, in order not to put continued operation of the cleaning device at risk. A next further development of the invention additionally provides that an alarm emitter element is assigned to the monitoring device. In case of clogging, in other words in case the filter has to be flushed, an alarm is preferably emitted at the same time. This indicates to the user of the cleaning device that the filter is clogged, and admonishes the user to clean the filter. In this connection, the alarm emitter element can be an optical or acoustical display; of course, it is also possible to trigger a remote alarm.

An exemplary embodiment of the invention, from which other characteristics of the invention are evident, is shown in the drawing. This shows:

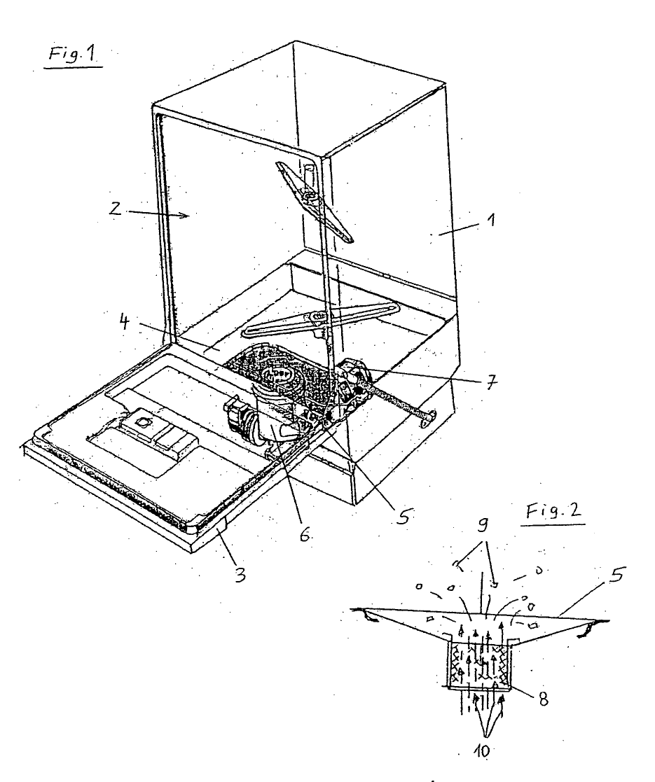

FIG. 1: a perspective view of a dishwasher, and

FIG. 2: a side view of a component of the dishwasher according to FIG. 1, on a larger scale.

The dishwasher 1 shown in FIG. 1 has a block-shaped dishwashing chamber 2, which is accessible by way of an opening that can be closed off with a flap 3. At the bottom 4 of the dishwashing chamber 2, a drain 5 is disposed, which is also shown in FIG. 2. This drain 5 is configured as a flat funnel. It empties into a pump 6, to which a drive 7 that is regulated in terms of speed of rotation is assigned.

A filter 8 (FIG. 2) is connected with the drain 5. The cleaning agent used in the dishwashing chamber 2, water in the case of this dishwasher, is passed to the pump 6 once again. On the way to the pump 6, the water passes out of the dishwashing chamber 2, through the drain 5 and the filter 8. In this connection, dirt particles 9 that have come off the items to be washed can clog the filter 8.

A monitoring device for determining the speed of rotation of the pump and/or the power consumption of the pump drive is assigned to the drive 7 of the pump 6. If an increase in power consumption or also an increase in the torque of the drive 7 occurs, while the speed of rotation of the pump 6 remains the same, the monitoring device determines that clogging of the filter 8 has taken place. In this case, a pressure surge is issued by way of a brief increase in the speed of rotation of the pump 6 which, as shown in FIG. 2, results in cleaning of the filter 8, by means of swirling up the dirt particles 9. Here, the pressure surge, as shown with arrows 10, takes place opposite to the normal direction of flow of the water. At the same time, an optical or acoustical display disposed in the flap 3, for example, can indicate to the user of the dishwasher 1 that clogging of the filter 8 has occurred.

1. Cleaning device having at least one cleaning region, preferably a dishwasher having a dishwashing chamber, comprising a drive for a pump, which drive is regulated in terms of speed of rotation, for a cleaning agent that is to be introduced into the cleaning region, preferably for water, which is passed in circulation through at least one filter,
wherein the speed of rotation regulator of the drive (7) has at least one monitoring device for determining the speed of rotation of the pump (6) and/or the power consumption of the pump drive assigned to it, and that the monitoring device is linked with the speed of rotation regulator in such a manner as to cause an increase in the speed of rotation.

2. Cleaning device according to claim 1,
wherein the monitoring device is alternatively designed to determine the torque of the drive (7).

3. Cleaning device according to claim 1,
wherein the speed of rotation regulator is, at the same time, the monitoring device.

4. Cleaning device according to claim 1,
wherein the monitoring device has an alarm emitter device assigned to it.

5. Cleaning device according to claim 4,
wherein the alarm emitter element is an optical or acoustical display.
